(19) United States
(12) Patent Application Publication
(10) Pub. No.: US 2008/0182765 A1
(43) Pub. Date: Jul. 31, 2008

(54) Aluminum Silicate Proppants, Proppant Production And Application Methods

(76) Inventors: Elena Mikhailovna Pershikova, Moscow (RU); Joseph E. O'Neill, Clamart Cedex (FR)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/959,092

(22) Filed: Dec. 18, 2007

(30) Foreign Application Priority Data
Dec. 27, 2006 (RU) 2006146363

(51) Int. Cl. C09K 8/92; C09K 8/60

(52) U.S. Cl. 507/271

(57) ABSTRACT

This invention relates to the oil and gas production industry and can be used for preventing fracture closing during fracturing of producing oil layers. Proppant comprising baked feedstock grains, with the difference that a burden material comprising silicon oxide and aluminum oxide at the aluminum oxide content of not less than 60% (by weight) is used as the feedstock; the apparent density of the proppant varies from 1.7 to 2.75 g/cm³

This application claims foreign priority benefits to Russian Patent Application No. 2006146363, filed on Dec. 27, 2006.

### FIELD OF THE INVENTION

This invention relates to the oil and gas industry, and in particular to preventing fracture closing during fracturing of producing oil layers.

### BACKGROUND

The statements in this section merely provide background information related to the present disclosure and may not constitute prior art.

A formation fracturing method for enhancing oil or gas production is known. A mixture of a fluid and a granulated material called the proppant is applied for securing open fractures. Sand, alumina, alumina alloys, milled charred coal, glass balls, clay, etc., are typically used as a grain-shaped material. Proppants made of ash agents, which are not broadly spread due to their low application properties, are also known. Sand being a natural cheap feedstock is widely used in practice. However, sand has a low conductivity and this feature restricts its application in the oil production process. Sand is generally used when gas is produced. (V. N. Moiseyev. Application of geophysical methods in the oil development process. M., “Nedra”, 1990, p. 105).

Proppants generally include aluminum oxides and silicon oxide, whose content affects qualitative properties of grains. Aluminum oxide improves strength properties whilst silicon oxide influences the elasticity of materials, which makes it possible to form spherical grains for a consequent hardening (mullitization) process. However, a large content of the said oxides does not always bring good results. For example, grains with alumina oxide content of up to 96% by weight are fragile, since they have a firm shell and a hollow core; this fact restricts practical application of the these grains. High-strength proppants are generally used at high depths where grain robustness is the main requirement. High-viscous fluids are used for injecting these proppants in fractures; this process is accompanied with a high power consumption and leads to increased costs of the hydrocarbon layer development.

The depth of the majority of Russian wells (≈83%) is rather small—down to 3,000 m. A medium-strength proppant, which requires low-viscosity fluid and small pressures for pumping into fractures, is an effective option for these wells.

A light-weight propping agent in the form of ceramic spherical grains made of a sintered kaolin clay comprising alumina, silica, iron and titanium oxides, is known. Meanwhile, oxides in these grains are available in the following weight ratios: alumina oxide—25-40%; silicon oxide—50-65%; iron oxide—1.6%; titanium oxide—2.6. Sphericity of grains is 0.7, where the sphericity is the minimum-to-maximum diameters ratio. This propping agent is the most effective option for development of oil or gas layers laid at small and medium depths.

The use of clays in which aluminum to silicium oxide ratio varies in a broad range is a major disadvantage of known proppants. Of the said range of components, proppants of the required quality can be produced at the aluminum oxide to silicium oxide weight ratio of 40%/50%, respectively. At another ratio, different additives are required to obtain grains of the required quality. This, in its turn, increase proppant production costs. For example, at the aluminum oxide to silicium oxide weight ratio of 25%/65%, low strength grains are produced. High-aluminum additives such as aluminum oxide are implemented to increase the strength of grains; as a result, primary costs of proppant grains grow. Besides, the content of iron oxides in this composition is rather high, and this fact adversely affects the strength properties of the proppant.

Proppants from a bauxite calcinated at 1,000° C. to improve the Al₂O₃/SiO₂ ratio are known. However, the primary cost of this proppant is higher.

Proppants obtained based on a bauxite and kaolin mixture are also known. This mixture provides the initial mass with elasticity and, therefore, allows to produce spherical and round proppants, however, at higher primary costs.

Two-layer proppants, whose inner part consists of an aluminosilicate substance with a rather low melting temperature, whilst the outer part with a high concentration of aluminum oxide contains alumina, are also known. Nephelinic syenites are suggested to be used as a substance with a low melting temperature, which is capable of forming a vitreous phase while cooling. To produce the above-mentioned proppants, a mixture of a burnt nephelinic syenite and fine-grained aluminum oxide is first granulated with the addition of water and a binding component. After drying, grains obtained in such a way are then mixed with a fine-grained aluminum oxide to prevent caking of grains with each other and their burning to the burning kiln walls. Burning in the rotating kiln is conducted at a temperature close to the nephelinic syenite melting point. Following the burn-out, grains are air blasted to remove unsintered aluminum oxide. After that, grains are subjected to re-burning in the rotating burning kiln at a higher temperature and with additional supply of aluminum oxide. During the re-burning process, a thicker surface layer of aluminum oxide is produced, which should ensure sufficient strength of proppants.

The disadvantage of the known engineering solution is a rather complex multi-phase proppant production technology featured with two power-consuming grain burning processes implemented in a rotating kiln. Besides, the increased apparent density of grains (over 2.75 g/cm³) dictates the application of fracturing fluids with the increased viscosity, which, in its turn, causes an abrasive wear of rocks and reduced the permeability of the rock, as well the supply of chemicals required to produce the formation fracturing liquid.

The application of proppants with decreased density could resolve the above-mentioned problems and, in addition, to provide effective conveyance of the propping agent over a longer length of the fracture and to increase well productivity.

Another proppant is also known. This proppant is produced based on sintered aluminosilicate feedstock or based on minerals, or from iron, steel, in the form of grains with a size of 6-100 mesh, preferably 10-40 mesh, with Krumbein's sphericity and roundness of not less than 0.8, density of 2.6 g/cm³, with a meltable phenolic resin coating. This proppant is applied in oil production, using the formation fracturing technology.

The disadvantage of the known engineering solution is a restricted functional capability of the proppants, since resin coatings only improve the proppant robustness and form a hydro-permeable seal to retain proppants from being carried over from wells. Proppants produced by using the prototype technology are not able to reduce water content in oil wells after the fracturing process is over.

### SUMMARY OF THE INVENTION

This invention relates to the oil and gas industry, and in particular to preventing fracture closing during fracturing of producing oil layers.

In a first embodiment, the invention is a proppant based upon baked feedstock grains, wherein a burden material comprising silicon oxide and aluminum oxide at the aluminum oxide content of not less than 60% (by weight) forms the feedstock grain, and the apparent density of the proppant varies from 1.7 to 2.75 g/cm³. The burden material may be composed of magnesium oxide, calcium oxide, titanium oxide, black iron oxides, alkaline and alkali-earth metal oxides, and manganese oxide at the following content by weight %:

| | |
|---|---|
| magnesium oxide | 1.0-10.0 |
| calcium oxide | 0.1-10.0 |
| titanium oxide | 0.1-10.0 |
| black iron oxides | 0.1-5.0 |
| alkaline and alkali-earth metal oxides | 0.01-2.0 |
| manganese oxide | 0.01-5.0 |

In another aspect of the invention, disclosed is a method of proppant production by providing for preliminary milling and mixing of initial components with their respective consequent granulation, drying and separation the components into target fractions, and where silicon oxide and aluminum oxide, in an amount not less than about 60% by weight, are used as the initial components. The method may further include the provision that prior to mixing, a clay constituent comprising aluminum oxide is first dissolved and is then subjected to dehydration to reach a moisture level required to ensure optimum parameters of the subsequent mixing and granulation processes. The burden material may be composed of magnesium oxide, calcium oxide, titanium oxide, black iron oxides, alkaline and alkali-earth metal oxides, and manganese oxide at the following content by weight %:

| | |
|---|---|
| magnesium oxide | 1.0-10.0 |
| calcium oxide | 0.1-10.0 |
| titanium oxide | 0.1-10.0 |
| black iron oxides | 0.1-5.0 |
| alkaline and alkali-earth metal oxides | 0.01-2.0 |
| manganese oxide | 0.01-5.0 |

In yet other embodiments, methods of treating subterranean formations to enhance hydrocarbon production are provided, where the method includes placing a proppant into a fracture formed in the formation, and where the proppant is baked feedstock grains based upon a burden material comprising silicon oxide and aluminum oxide at the aluminum oxide content of not less than 60% (by weight). The apparent density of the proppant varies from 1.7 to 2.75 g/cm³. The burden material contain magnesium oxide, calcium oxide, titanium oxide, black iron oxides, alkaline and alkali-earth metal oxides, and manganese oxide at the following content by weight %:

| | |
|---|---|
| magnesium oxide | 1.0-10.0 |
| calcium oxide | 0.1-10.0 |
| titanium oxide | 0.1-10.0 |
| black iron oxides | 0.1-5.0 |
| alkaline and alkali-earth metal oxides | 0.01-2.0 |
| manganese oxide | 0.01-5.0 |

### DESCRIPTION OF THE INVENTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

Disclosed are compositions and methods of using compositions of burden materials which allow production of proppants which effectively operate when formation fracturing technology and gravel-packed filters are used. Methods, compositions, and compositional physical properties of the invention make possible to enlarge the length of fractures due to a reduced rate of settling in a gel which was used to deliver proppant to the fracture. As a result, the fracture productivity grows. Furthermore, reduced density of proppant significantly decreases the consumption of chemicals required for preparing a lower-viscosity gel for proppant transportation inside the fracture.

For achieving the above-mentioned result, a proppant of sintered feedstock grains, where a burden material including silicon oxide and aluminum oxide at a ratio of not less than 60% by weight, is used as a feedstock. In one case, the apparent density of the proppant varies from 1.7 to 2.75 g/cm³. Besides, the burden material could additionally include at least one of the following components: magnesium oxide, calcium oxide, titanium oxide, black iron oxides, alkaline and alkali-earth metal oxides and manganese oxide at the following content of the above-mentioned components (by weight, %):

| | |
|---|---|
| Magnesium Oxide | 1.0-10.0 |
| Titanium Oxide | 0.1-10.0 |
| Calcium Oxide | 0.1-10.0 |
| Black Iron Oxides | 0.1-5.0 |
| Black Iron Oxides | 0.01-2.0 |
| Manganese Oxide | 0.01-5.0 |

The method applied for production of the said proppant calls for preliminary milling and mixing of initial components with a follow-up granulation of the initial components, drying and splitting of these components into target fractions. Silicon oxide and aluminum oxide with aluminum oxide content of not less than 60% (by weight) are used as the said the initial components. In one embodiment, before the mixing stage, a clay constituent comprising aluminum oxide is first dissolved and is then subjected to dehydration to reach a moisture level required to ensure optimum parameters of the subsequent mixing and granulation processes. Generally, a burden material is used, which additionally contains at least one of the below listed components: magnesium oxide, calcium oxide, titanium oxide, black iron oxides, alkaline and alkali-earth metal oxides and manganese oxide at the following content of the above-mentioned components (by weight):

| | |
|---|---|
| Magnesium Oxide | 1.0-10.0 |
| Titanium Oxide | 0.1-10.0 |
| Calcium Oxide | 0.1-10.0 |
| Black Iron Oxides | 0.1-5.0 |
| Alkaline And Alkali-Earth Metal Oxides | 0.01-2.0 |
| Manganese Oxide | 0.01-5.0 |

In the basic option, the newly developed proppant could be produced as follows: initial components roasted if required are milled to allow passage of 90% of the product through a 63 μm mesh sieve. If required, plasticizers and other supporting materials are added in the initial materials. Either a separate or combined milling method could be employed. Initial components are often mixed either in mills (if a combined milling process has not been employed before this) or in a granulating machine itself. While mixing, a temporary process binder is added, if required, in the amount sufficient enough for formation of spherical particle nucleuses and for further growth of these nucleuses to required sizes. The amount of the temporary process binder varies from 3 to 20% (by weight); total time required for mixing and granulation is 2 to 10 minutes. The binder could be represented by water, water and organic polymer solutions, latexes, micro-wax, paraffin, etc. Once the nucleuses have been formed and grain has grown to the required size from the mixture previously introduced in the graining machine, up to 12% (by weight) of initial milled mixture is then introduced to the graining machine, and thereafter a mixing process which lasts up to 3 minutes is implemented. Grains prepared using the above-mentioned procedure are then dried and dispersed to the sizes allowing the compensation of a shrinkage occurred in the roasting process. Grains, which do not meet the established size requirements, could be recycled. If during the mixing and granulation processes, the temporary organic binders were used, a preliminary roasting to burn-out the said binders could be implemented. Grains dried and classified by size are then roasted at temperatures and exposure periods required for providing apparent density of up to 2.75 g/cm³. Following roasting, additional separation into fractions could be implemented.

Despite the technology for the proposed proppant application does not differ from a standard technology, the application of the said proppant makes it possible, due to a qualitative and quantitative composition of the proppant as well as due to its unique intrinsic physical & chemical properties, to dramatically improve proppant transportation deep into fractures owning to decreased rate of its settlement in a gel, reduce consumption of chemicals for preparing fracturing fluids, since gels with a lower viscosity will be required for proppant transportation. In its turn, this decreases abrasive wear of rocks in the fracture and enhances the application efficiency.

Further on, the developed engineering solution will be studied based on its embodiments.

1. While implementing the engineering solution developed, pre-milled bauxites from the Boksonskoye deposit were mixed with the Glukhovetsky kaolin and calcium & magnesium carbonates to form an initial burden material of the following composition (%, by weight):

| | |
|---|---|
| Aluminum Oxide | 67.4 |
| Silicon Oxide | 27.6 |
| Magnesium Oxide | 1.9 |
| Calcium Oxide | 1.0 |
| Titanium Oxide | 1.0 |
| Black Iron Oxide (Iii) | 0.1 |
| Black Iron Oxide (Ii) | 1.0 |

Compositions of initial burden material used in the commercial proppant production are specified in Table 1 for comparison.

TABLE 1

| | Weight. % | | | | | | |
|---|---|---|---|---|---|---|---|
| | Al₂O₃ | SiO₂ | MgO | CaO | TiO₂ | Fe₂O₃ | FeO |
| Example 1 | 67.4 | 27.6 | 1.9 | 1.0 | 1.0 | 0.1 | 1.0 |
| CarboProp | 72 | 13 | | | 4 | 10 | |
| (USA) | | | | | | | |
| CarboLite(USA) | 51 | 45 | | | 2 | 1 | |
| EconoProp(USA) | 48 | 48 | | | 2 | 1 | |

Comparative parameters obtained during the study of proppant compositions specified in Table 1 and tested as per API PR 60, are presented in Table 2.

TABLE 2

| | VALUE | | | | |
|---|---|---|---|---|---|
| | RECOMMENDED | | | | |
| | AS | CARBOPROP | CARBOLITE | ECONOPROP | |
| PARAMETER | PER API60 | (USA) | (USA) | (USA) | EXAMPLE 1 |
| Sphericity | >0.7 | 0.9 | 0.9 | 0.9 | 0.9 |
| Roundness | >0.7 | 0.9 | 0.9 | 0.9 | 0.9 |
| Bulk density | — | 1.88 | 1.57 | 1.56 | 1.61 ± 0.00 |
| Apparent density | — | 3.27 | 2.71 | 2.70 | 2.74 ± 0.01 |

Example 2 is illustrated by Tables 3 & 4. In these tables, compositions of the initial burden material and parameters of obtained proppants tested as per API RP 60 are indicated. While implementing Example 2, preliminary and separately milled components—bauxites of the Kiya-Shaltyrskoye deposit, dolomite and kaolin from the Polozhskoye deposit—are mixed.

TABLE 3

| | Weight, % | | | | | | |
|---|---|---|---|---|---|---|---|
| | Al₂O₃ | SiO₂ | MgO | CaO | TiO₂ | Fe₂O₃ | FeO |
| Example 2 | 62.0 | 32.5 | 3.2 | 1.0 | 0.3 | 0.1 | 0.9 |
| EconoProp | 48 | 48 | | | 2 | 1 | |
| (USA) | | | | | | | |

TABLE 4

| | VALUE | CARBO | |
|---|---|---|---|
| | RECOMMENDED | ECONOPROP | |
| | AS PER | 3050 | |
| PARAMETER | API60 | (USA) | EXAMPLE 2 |
| Sphericity | >0.7 | 0.9 | 0.9 |
| Roundness | >0.7 | 0.9 | 0.9 |
| Bulk density | — | 1.56 | 1.57 ± 0.00 |
| Apparent | — | 2.70 | 2.58 ± 0.01 |
| density | | | |

Example 3 is illustrated by data indicated in Table 5 (initial burden material data) and in Table 6 (physical properties of proppants tested as per API RP 60). While implementing the example, kaolins of the Poletayevskoye deposit and bauxites of the Tatulskoye deposit were mixed.

TABLE 5

| | Weight, % | | | | | | |
|---|---|---|---|---|---|---|---|
| | Al₂O₃ | SiO₂ | MgO | CaO | TiO₂ | Fe₂O₃ | FeO |
| Example 2 | 65 | 28 | 3.2 | 1.0 | 0.3 | 2.5 | — |
| CarboLite | 51 | 45 | | | 2 | 1 | |

TABLE 6

| | VALUE | | |
|---|---|---|---|
| | RECOMMENDED | | |
| | AS PER | CARBOLITE | |
| PARAMETER | API60 | 1620 | EXAMPLE 3 |
| Sphericity | >0.7 | 0.9 | 0.9 |
| Roundness | >0.7 | 0.9 | 0.9 |
| Bulk density | — | 1.57 | 1.57 ± 0.00 |
| Apparent | — | 2.71 | 2.58 ± 0.01 |
| density | | | |

Apparent density of the developed proppant shown in the examples above allows reduction in the rate of proppant settlement in gels, and, therefore ensures the proppant conveyance to a longer length of fractures and therefore increases the productivity of wells.

We claim:

1. A proppant comprising baked feedstock grains, wherein a burden material comprising silicon oxide and aluminum oxide at the aluminum oxide content of not less than 60% (by weight) comprises the feedstock grain, and the apparent density of the proppant varies from 1.7 to 2.75 g/cm³

2. The proppant of claim 1 wherein the burden material comprises magnesium oxide, calcium oxide, titanium oxide, black iron oxides, alkaline and alkali-earth metal oxides, and manganese oxide at the following content of the above-mentioned components by weight % are:

| | |
|---|---|
| magnesium oxide | 1.0-10.0 |
| calcium oxide | 0.1-10.0 |
| titanium oxide | 0.1-10.0 |
| black iron oxides | 0.1-5.0 |
| alkaline and alkali-earth metal oxides | 0.01-2.0 |
| manganese oxide | 0.01-5.0 |

3. A method of proppant production, the method comprising providing for preliminary milling and mixing of initial components with their respective consequent granulation, drying and separation the components into target fractions, wherein silicon oxide and aluminum oxide are used as the initial components, and wherein content of the aluminum oxide is not less than about 60% by weight.

4. The method of claim 3 wherein prior to mixing, a clay constituent comprising aluminum oxide is first dissolved and is then subjected to dehydration to reach a moisture level required to ensure optimum parameters of the subsequent mixing and granulation processes.

5. The method of claim 4 wherein a burden material is used, wherein the burden material comprises magnesium oxide, calcium oxide, titanium oxide, black iron oxides, alkaline and alkali-earth metal oxides, and manganese oxide at the following content of the above-mentioned components by weight % are:

| | |
|---|---|
| magnesium oxide | 1.0-10.0 |
| calcium oxide | 0.1-10.0 |
| titanium oxide | 0.1-10.0 |
| black iron oxides | 0.1-5.0 |
| alkaline and alkali-earth metal oxides | 0.01-2.0 |
| manganese oxide | 0.01-5.0 |

6. A method of treating a subterranean formation to enhance hydrocarbon production, the method comprising placing a proppant into a fracture formed in the formation, wherein the proppant comprises baked feedstock grains, wherein a burden material comprising silicon oxide and aluminum oxide at the aluminum oxide content of not less than 60% (by weight) comprises the feedstock grain, and the apparent density of the proppant varies from 1.7 to 2.75 g/cm³

7. The method of claim 6 wherein the burden material comprises magnesium oxide, calcium oxide, titanium oxide, black iron oxides, alkaline and alkali-earth metal oxides, and manganese oxide at the following content by weight %:

| | |
|---|---|
| magnesium oxide | 1.0-10.0 |
| calcium oxide | 0.1-10.0 |
| titanium oxide | 0.1-10.0 |
| black iron oxides | 0.1-5.0 |
| alkaline and alkali-earth metal oxides | 0.01-2.0 |
| manganese oxide | 0.01-5.0 |
